(19) United States
(12) Patent Application Publication
(10) Pub. No.: US 2007/0266584 A1
(43) Pub. Date: Nov. 22, 2007

(54) Golf Tee Height Marker

(76) Inventor: Ryan Robert Munson, Tampa, FL (US)

Correspondence Address: RYAN MUNSON, 11024 GREENAIRE DR, TAMPA, FL, 33624, US

(21) Appl. No.: 11/308,880

(22) Filed: May 20, 2006

(51) Int. Cl. B25H 7/00

(52) U.S. Cl. 33/666

(57) ABSTRACT

A golf tee marker with adjustable height and guide includes a base formed to receive and retain a golf tee, a graduated shaft and an integrated marking device. The graduated shaft protrudes from the base to provide means for holding the marking utensil at various heights. The marking utensil has the ability to travel up or down the shaft to various distances from the base where it can be fastened. This gives the user the ability to produce accurate height marks on the shaft of the golf tee at a set distance from the top of the tee.

### BACKGROUND OF THE INVENTION

1. Field of the Invention

The invention relates, in general, to golfing aids, and, in particular, to devices for setting golf tee height.

2. Description of the Prior Art

The game of golf has a great many number of variables to be over come to produce a consistently good game. Reducing this number of variables stands to help improve a golfers game. One such area that can be improved is the placing of the tee. The tee height has an impact on where the ball strikes the head of the club. Placing the tee at the correct height consistently will improve the consistency of drive. There are various devices for setting golf tees at a predetermined height accurately and consistently. Of these devices, two types are most prominent. The first type being a device that aids in inserting the tee in the ground. U.S. Pat. No. 4,982,510 to Musillo (1991) discloses a golf tee gauge is in the form of a pad having a plurality of depressions into which the head portion of a golf tee may be selectively inserted to obtain selective lengths of penetration of the golf tee stem into the ground. The device itself is what gauges the height of the golf tee while the tee is in the ground. Some limitations of this approach is that device must be used at the time the tee is inserted in the ground and that the gauge has set steps of height not a infinitely variable height selection to suit any golfer.

The second most prevalent approach to accurately set the height of a golf tee is to redesign the tee itself. Several designs of golf tees have notches, steps or markings on the tee. One such approach is disclosed in U.S. Pat. No. 5,356,146 to Blosser (1994) disclosing a golf tee with stripes on the shaft. The stripes are at set heights giving the golfer the ability to consistently set the golf tee at specific height. Limitations of this approach are that the stripes are set by the manufacturer to preset heights not set by the golfer to the height that particular golfer needs. One other limitation is that these tees are not as readily available as standard golf tees.

The aforementioned patents do improve the consistency of golf ball height however; they do not make infinitely variable height marks on ordinary golf tees.

### SUMMARY OF THE INVENTION

The present invention is a device for marking a desired height or insertion depth mark on the shaft of a golf tee. The invention provides a base that supports or retains the head of a standard golf tee, a graduated shaft that protrudes tangent from the base and a marking utensil that extends from the shaft parallel to the base. The distance between the marking utensil and the base may be variably adjustable providing a means for the user to set the desired height mark on the golf tee. Once the mark has been set on the tee, the golfer will be able to insert the tee in the ground at the exact height marked on the tee. This gives the user the ability to pre-mark the tees to an exact height before a golf outing.

### BRIEF DESCRIPTION OF THE DRAWINGS

FIG. 1 is an isometric view of the preferred embodiment with a golf tee in place for reference.

FIG. 2 is an isometric view of the preferred embodiment from the front angle.

FIG. 3 is an isometric view of the preferred embodiment from the back angle.

FIG. 4 is a side plan view of the preferred embodiment.

### DESCRIPTION OF THE PREFERRED EMBODIMENT

The present invention is a device for marking an insertion height line on a standard golf tee. The line on the golf tee tells the golf how deep to insert the tee in to the ground to have a consistent height of the golf ball each time he/she tees off.

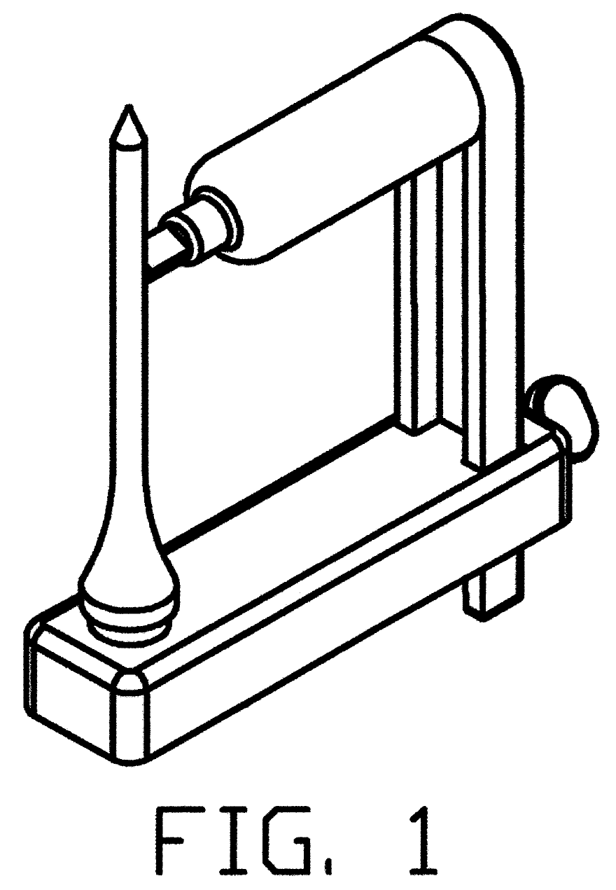

FIG. 1 depicts the preferred embodiment with a standard golf tee in place to give reference of how the device is used. A golf tee is spun on the device between the thumb and forefinger of the user to produce a line on the shaft of the golf tee.

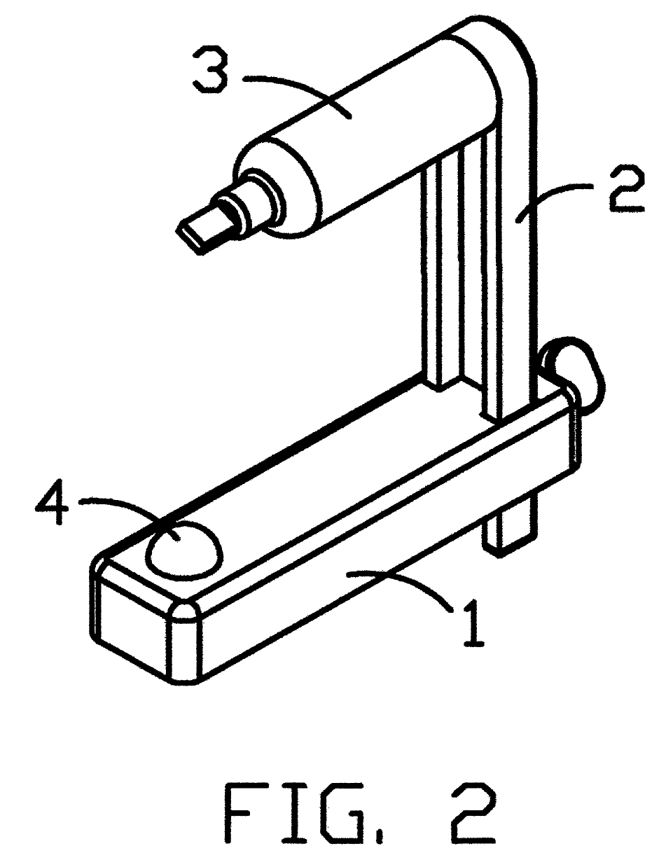

FIG. 2 shows the device without the golf tee. The base 1 of the device has a raised dome 4 where the head of a golf tee may pilot. An arm 2 protrudes perpendicular to the base. A marker 3 is attached perpendicularly to the arm 2 and parallel to the base 1.

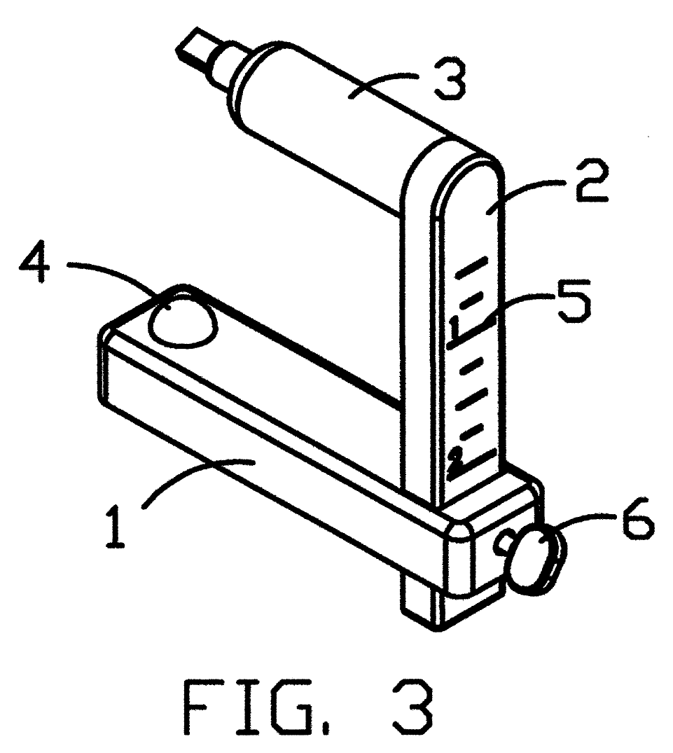

FIG. 3 is an isometric view of the back of the device showing the graduated marks 5 on the arm 2 which indicate the height of the marker 3 from the base 1. The user has the ability loosen screw 6 which allows arm 2 to slide in and out of the base 1 to the desired height. The screw 6 could then be tightened so that the height marks on the golf tee can be accurately repeated from tee to tee.

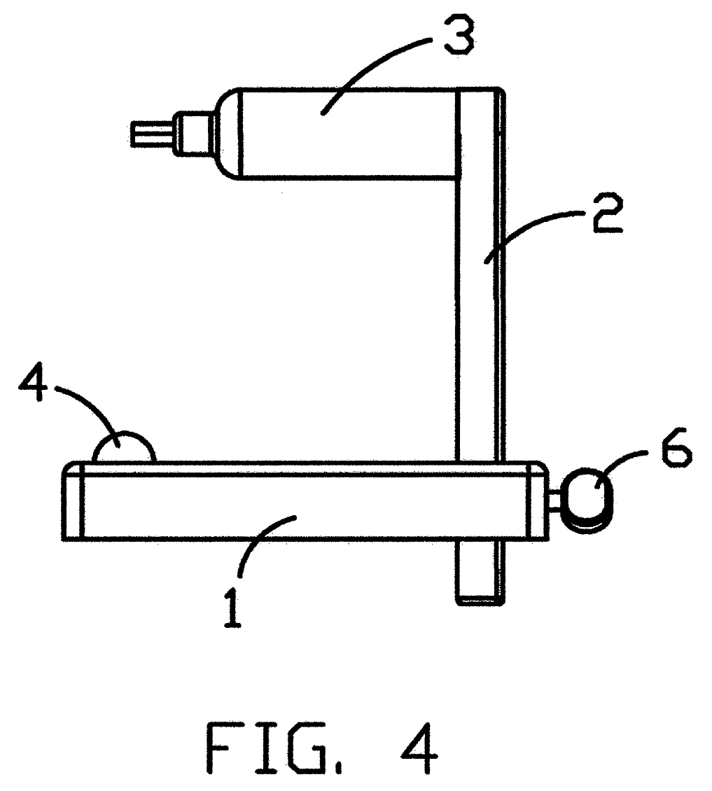

FIG. 4 is a side plan view of the preferred embodiment showing the base 1, the arm 2 intersecting the base 1 and the marker 3 protruding from the arm 2.

What is claimed is:

1. A golf tee height marker comprising: a means to measure a set distance from the top of to a golf tee and a marking device to produce a mark on the shaft of said golf tee.
